(19) United States
(12) Patent Application Publication
(10) Pub. No.: US 2013/0199316 A1
(43) Pub. Date: Aug. 8, 2013

(54) MECHANICAL DEVICE WITH VARIABLE-LENGTH LEVER ARM

(71) Applicant: Patrice Magnard, Paris (FR)

(72) Inventor: Patrice Magnard, Paris (FR)

(73) Assignee: MAGNARD INNOVATION, Paris (FR)

(21) Appl. No.: 13/820,482

(22) PCT Filed: Sep. 2, 2011
(86) PCT No.: PCT/FR11/52020

§ 371 Date: Apr. 25, 2013

(30) Foreign Application Priority Data
Sep. 2, 2010 (FR) 1056960

(51) Int. Cl. F16H 21/22

(52) U.S. Cl. CPC F16H 21/22
USPC 74/45

(57) ABSTRACT

A mechanism which comprises at least one fulcrum element connected to at least one force transmission rod by a connecting member is provided. The mechanism may convert a reciprocating rectilinear movement into a rotational movement of the at least one fulcrum element. The rotation of the at least one fulcrum element may cause the at least one force transmission rod to rotate. The connecting member comprises a part, known as a lever arm that may be situated between the at least one fulcrum element and the at least one force transmission rod and has a length that varies during the relative movement of the at least one fulcrum element with respect to the at least one transmission rod.

The present invention relates to a device for increasing engine power and performance, in particular for vehicles that use a reciprocating rectilinear force as a power source. This is in particular the case for vehicles using piston heat engines as well as cycles using a pedal crank device.

Traditionally, the mechanical forces generated by sources of the reciprocating rectilinear type are exerted on lever arms (pedal/crank, connecting rod/crankshaft, etc.) of a mechanism and are converted by that mechanism into continuous forces on a primary shaft (shaft supporting the pedal, shaft of the crankshaft, etc.), thereby causing it to rotate.

Currently, the performance of engines, such as vehicle engines, using the forces resulting from such a reciprocating rectilinear movement as a power source, is limited by the travel of the reciprocating rectilinear movement. This movement determines the length of the lever arm, which must be as long as possible.

For example, for cycles, the length of the pedal arm (or crank) is limited by the size of the cyclist's legs, and for piston heat engines, the distance between the shaft of the crankshaft and the crankshaft arm (connecting rod support on the crankshaft) is limited by the travel of the piston.

It would be very useful to be able to increase the power of engines of the type mentioned above.

To that end, the present invention proposes a mechanism that includes at least one fulcrum element connected to at least one force transmission rod, the mechanism converting a reciprocating rectilinear movement into a rotational movement of said at least one fulcrum element, the rotation of said at least one fulcrum element rotating said at least one force transmission rod, characterized in that the connecting member comprises a part, called a lever arm, in particular situated between said at least one fulcrum element and said at least one force transmission rod and which has a length that varies over the course of the relative movement of said at least one fulcrum element relative to said at least one transmission rod.

In this way, the variation of the length of the lever arm during a complete rotation cycle of said at least one fulcrum element makes it possible to more efficiently use the reciprocating rectilinear force communicated to the mechanism of the engines of the type mentioned above.

It will be noted that the reciprocating rectilinear force produced is positive over part of the rectilinear cycle and is negative or zero over the remaining part of the cycle.

The invention in particular makes it possible to increase the length of the lever arm during the part of the cycle where the force exerted is positive, while preserving a travel of the reciprocating rectilinear movement that is identical to that of the conventional mechanism.

In particular, in a piston heat engine, up to a limit determined by the capacity to compress the gases of a mixture used in the engine, only the positive part of the reciprocating rectilinear force is of interest for operating an engine.

In fact, the force exerted during the negative part of the reciprocating cycle is zero, or even reverse motive force (resistance force) on reciprocating rectilinear movement heat engines.

The same is true on cycles, with the exception of those equipped with foot braces for which a lower-intensity positive force may contribute to driving the primary shaft supporting the chain ring of the chain.

The device according to the invention also makes it possible to increase the angle of exertion of the force relative to the rod of the lever arm, during the first half of positive exertion of the force, relative to a traditional mechanism. The device also makes it possible to decrease that force less during the second half of positive exertion of the force, with a travel of the rectilinear movement identical to that of a traditional mechanical device.

In corollary, the length of the lever arm relative to said at least one transmission rod is decreased proportionally on the part of the cycle where the exerted force is negative or zero.

According to one characteristic, said at least one fulcrum element cooperates with a circular or ovoid guide during its rotational movement.

Said at least one fulcrum element has means and/or a shape allowing it to cooperate mechanically with the guide during the rotation.

The guide for example also comprises means and/or a complementary shape for cooperation purposes.

It will be noted that a guide is for example provided for each fulcrum element. According to one characteristic, said at least one force transmission rod is off-centered relative to the geometric center of the guide.

The force transmission rod on which one end of the lever arm is fixed (the other end being fixed to the fulcrum element(s)) is subjected to the force exerted by the lever arm.

This force transmission rod is situated on a straight line perpendicular to the direction along which the reciprocating rectilinear movement is occurs the action of the stress or initial force transmitted to the mechanism.

The further the force transmission rod is from the geometric center of the circular or ovoid guide, toward the area of the guide (half-circle or half-ovoid) where the reciprocating rectilinear stress is exerted negatively, while remaining inside the guide, the longer the length of the lever arm is when the reciprocating rectilinear stress is positive and the shorter the length of the lever arm is when the reciprocating rectilinear stress is negative.

According to another characteristic dependent on the preceding characteristic, the force transmission rod is situated on a straight line that is perpendicular, on the one hand, to the direction of the reciprocating rectilinear movement, and, on the other hand, to the plane in which said at least one fulcrum element moves, the force transmission rod being off-centered from the geometric center of the guide by a distance of 0.1% to 99.9% of the average radius of the guide.

The force transmission rod is preferably positioned in the inner area of the guide where the reciprocating rectilinear stress is exerted negatively or not at all.

According to one characteristic, the mechanism may comprise two fulcrum elements each connected, by a lever arm, to a force transmission rod.

It will be noted that each lever arm may in turn be connected to a single force transmission rod or several force transmission rods.

According to one characteristic dependent on the preceding characteristic, the mechanism comprises two force transmission rods, each lever arm thus being connected to a different force transmission rod.

According to one characteristic, the lever arm is secured to said at least one fulcrum element and said at least one force transmission rod is slidingly mounted relative to the lever arm.

According to one alternative characteristic, the lever arm is secured to said at least one force transmission rod and said at least one fulcrum element is slidingly mounted relative to the lever arm.

According to another alternative characteristic, the lever arm is secured to said at least one fulcrum element and said at least one force transmission rod and is telescopic so as to deploy and retract during the rotational movement.

In this way, the lever arm is fixed both to the fulcrum element on which the reciprocating rectilinear force is exerted and to the fastening point on the force transmission rod.

According to still another alternative characteristic, said at least one fulcrum element and said at least one force transmission rod are slidingly mounted relative to the lever arm.

The preceding four alternative characteristics illustrate different embodiments of a lever arm with a variable length connected on the one hand to at least one fulcrum element, and on the other hand to at least one force transmission rod.

It will be noted that other embodiments can be considered to produce the arrangement of a variable-length lever arm connected to at least one fulcrum element and at least one force transmission rod.

According to one characteristic, the device briefly described above may advantageously be applied to a cycle using a pedal crank mechanism in which each pedal constitutes a fulcrum element that is connected to a force transmission rod by a crank arm.

The invention thus applied to a cycle makes it possible to increase the power and performance of the cycle, as well as the peddling comfort.

According to one characteristic dependent on the previous characteristic, each force transmission rod is connected to a complementary mechanism for reestablishing the symmetrical position of the two pedals relative to one another with respect to the geometric center of the guide with which each pedal cooperates.

According to one characteristic, each complementary mechanism comprises a pair of ovoid (for example elliptical) gear rings mechanically cooperating with each other, one of the rings, called the first ring, being connected to the corresponding force transmission rod.

According to another characteristic, the two rings of the two pairs are connected to each other by a transmission rod, a set of gears connecting said transmission rod to a chain ring of the cycle and a set of gears arranged between the chain and a rear pinion.

The last possibility according to which the transmission rod is directly connected to a chain ring of the cycle and where a set of gears is arranged between the chain and a rear pinion offers greater flexibility to the possible arrangement of the different elements relative to each other.

Thus, the chain can be made in two parts, a first part connecting the chain ring of the cycle to part of the set of gears and a second part of the chain connecting another part of the set of gears to the rear pinion.

For example, the set of gears is not necessarily arranged aligned with the chain ring and the rear pinion, but can be offset relative to the longitudinal axis connecting them.

Instead of using a set of gears that connects the transmission rod connecting the two rings of the two pairs to each other to a chain ring of the cycle, the second rings of those two pairs of rings are directly connected to a chain ring of the cycle, the chain connecting the chain ring of the cycle to a rear pinion then being crossed between the latter so as to form an 8.

According to one possible characteristic, the cycle includes at least one element for maintaining a lateral separation between the two longitudinal portions or chain strands that intersect.

Said at least one element for maintaining the separation is substantially arranged in the area where the two longitudinal portions or chain strands intersect.

Said at least one element for maintaining the lateral spacing thereby allows the chain portions to intersect without creating friction between those portions that would be detrimental to the operation of the cycle.

According to one possible characteristic, said at least one element for maintaining the lateral spacing comprises, for each longitudinal portion or chain strand, two longitudinal guide elements for guiding said portion or said strand that keep said portion or strand away from the other portion or strand.

Each element may for example assume the form of a guide wheel cooperating with a longitudinal portion or a chain strand.

According to one possible alternative, said at least one element for maintaining the lateral spacing is arranged between the two longitudinal portions at their intersection area.

According to another embodiment, the set of gears connecting the transmission rod to a chain ring of the cycle may be eliminated and the chain ring of the cycle and/or the rear pinion of the cycle is inclined relative to a vertical plane.

Several arrangements are possible.

Thus, the chain ring may be inclined relative to a vertical plane while the rear pinion remains arranged vertically in its plane.

According to another possibility, the chain ring of the cycle is inclined, as is the rear pinion, for example at the same incline.

According to still another possibility, the rear pinion may be inclined relative to a vertical plane while the chain ring remains arranged vertically.

According to one possible characteristic, guides fixed to the frame of the cycle are provided on either side of the chain ring so as to keep the latter in the inclined position during the rotational movement.

According to one possible characteristic, when the chamber is inclined relative to a vertical plane, the chain ring is mounted on a hub including interlocking elements complementary to those provided on the chain ring so as to allow the plate to be assembled on the hub by interlocking and for those parts to be rotated.

Interlocking elements arranged on the chain ring and the hub matching each other (for example, alternating hollows and projections) allow those two parts to mesh with each other.

According to another possible characteristic, the hub has a generally elliptical shape that is elongated along an axis perpendicular to the vertical plane.

The chain ring is thus arranged inclined on the ellipse, while being inclined both relative to a vertical plane and relative to the longitudinal axis of the ellipse.

According to another possible characteristic, the second rings are connected to each other by a transmission rod on which the hub is mounted.

The transmission rod corresponds to the axis along which the general ellipsoid shape is elongated.

According to one alternative embodiment, the two gear plates of each pair are connected to each other using the chain and are therefore no longer in direct contact with each other.

Owing to this arrangement, the two plates of the two pairs are connected to each other by a transmission rod that is directly connected to the chain ring.

The device according to the invention is also applicable to a piston heat engine in which the crankshaft arm comprises two opposite ends making up two fulcrum elements and two crankshaft crank arms making up the lever arms that respectively connect the two opposite ends of the crankshaft arm to the two crankshaft shanks making up two force transmission rods.

Furthermore, the device according to the invention may be applied to other types of engines in which a reciprocating rectilinear force is communicated to a mechanism converting the reciprocating rectilinear movement into a rotational movement (circular or semicircular).

Other characteristics and advantages will appear during the following description, provided solely as a non-limiting example and done in reference to the appended drawings, in which:

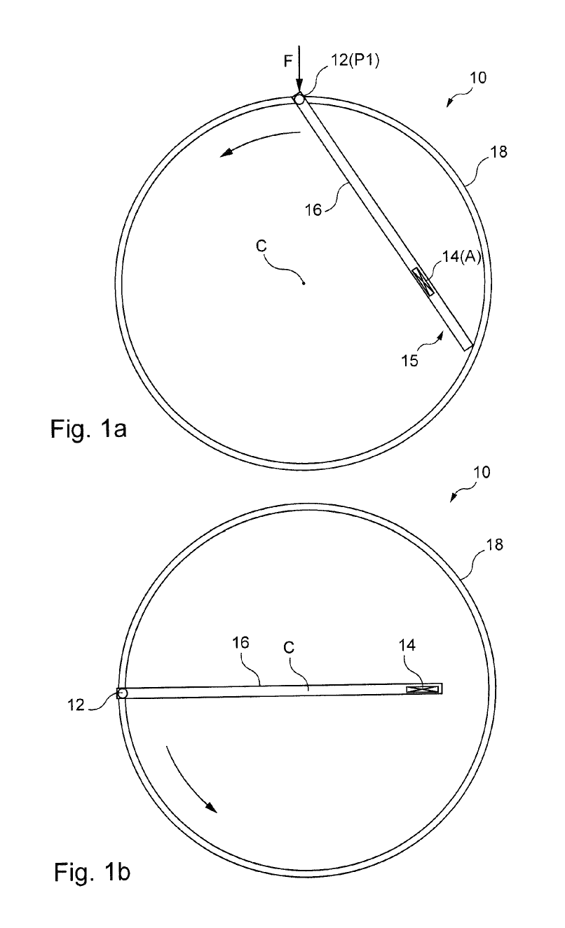

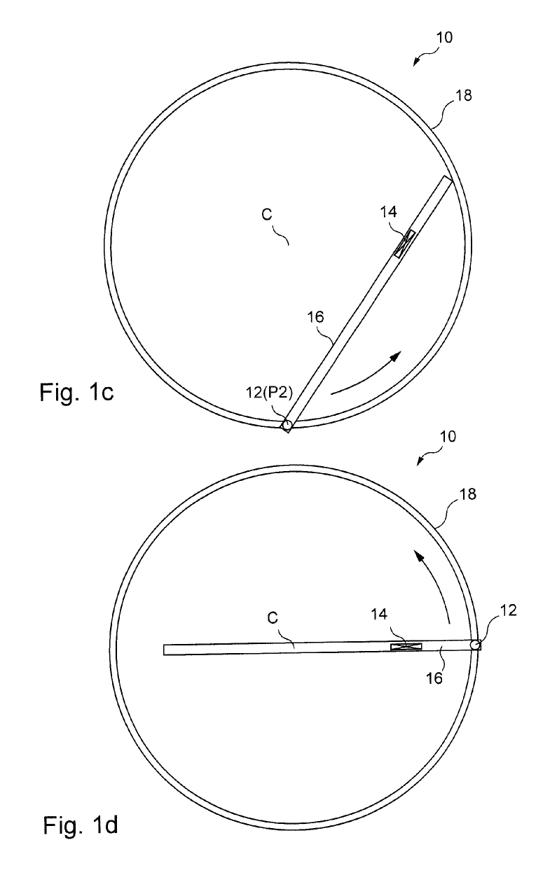

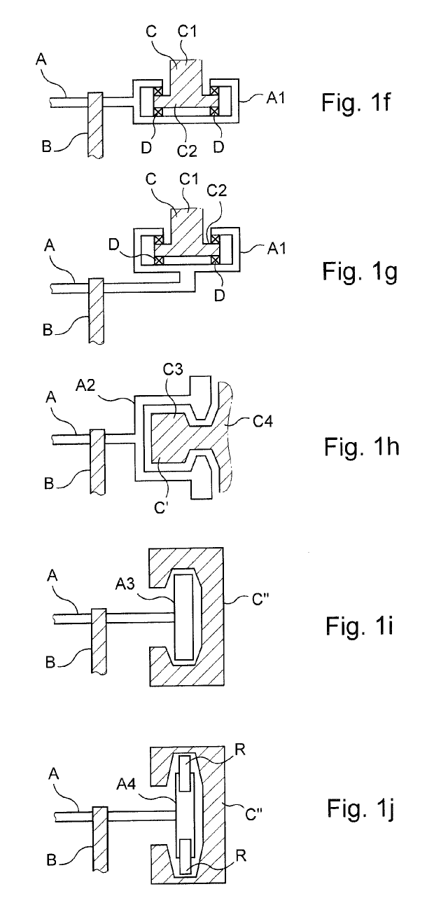

FIGS. 1a to 1d illustrate a first embodiment of a mechanism according to the invention;

FIG. 1e illustrates an enlarged partial perspective view of the mechanism of FIGS. 1a to 1d;

FIGS. 1f to 1j illustrate different embodiments of the cooperation between a fulcrum element and a guide;

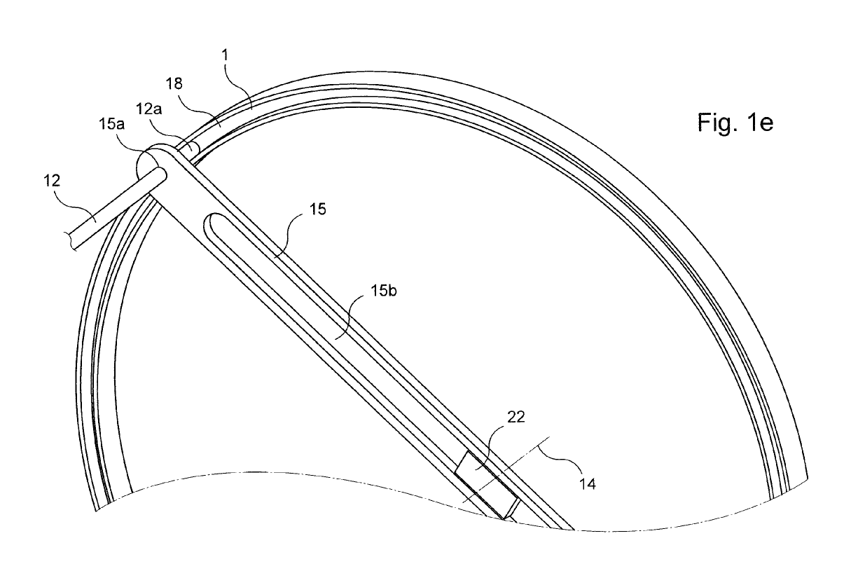

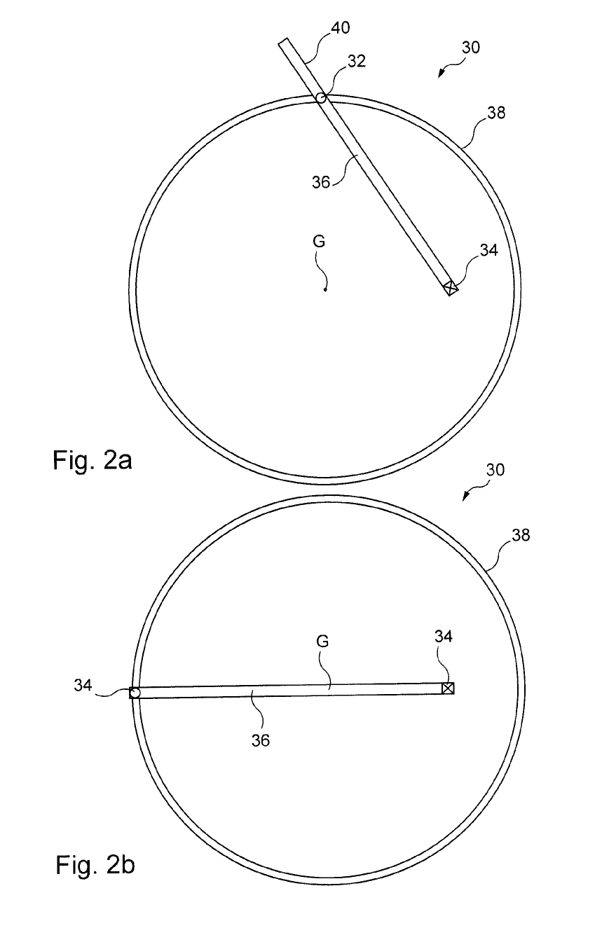

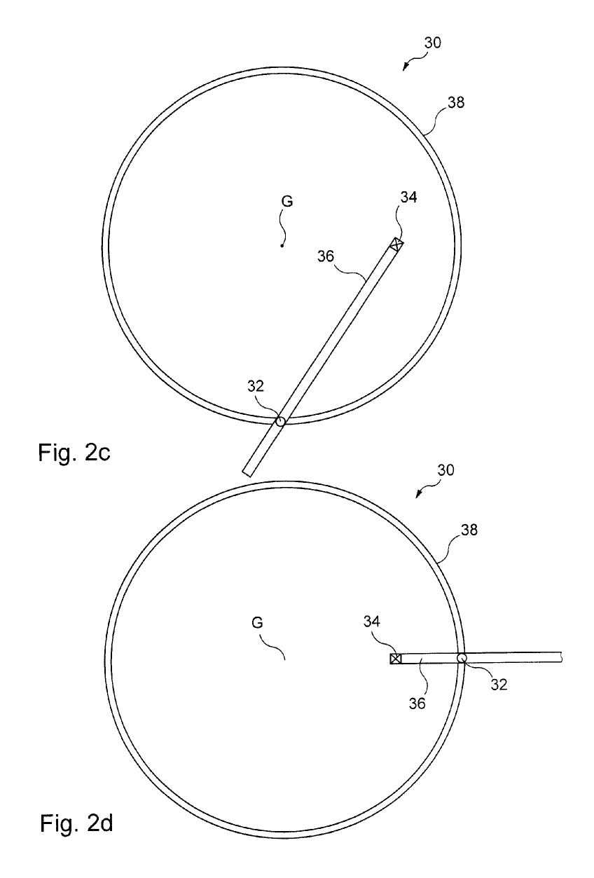

FIGS. 2a to 2d illustrate a second embodiment of the mechanism according to the invention;

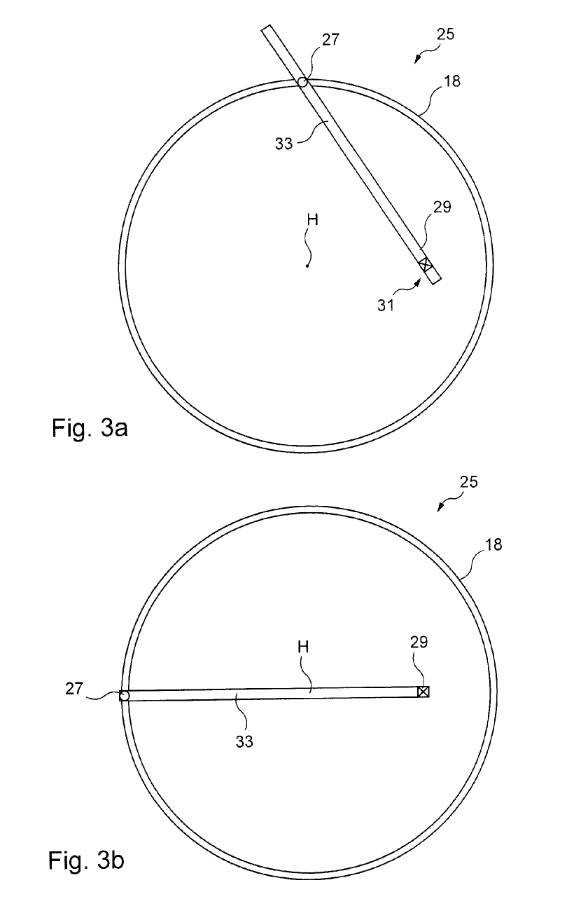

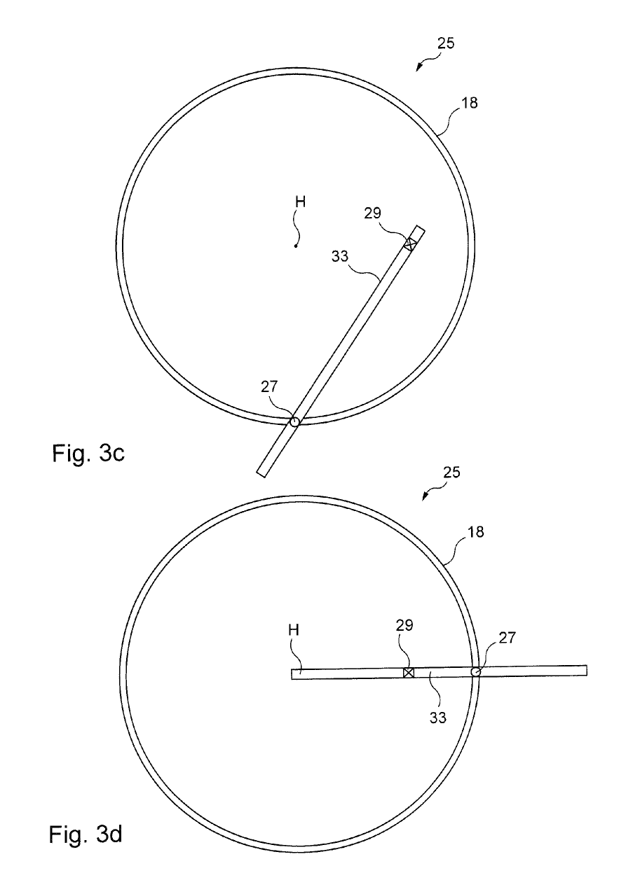

FIGS. 3a to 3d illustrate a third embodiment of the mechanism according to the invention;

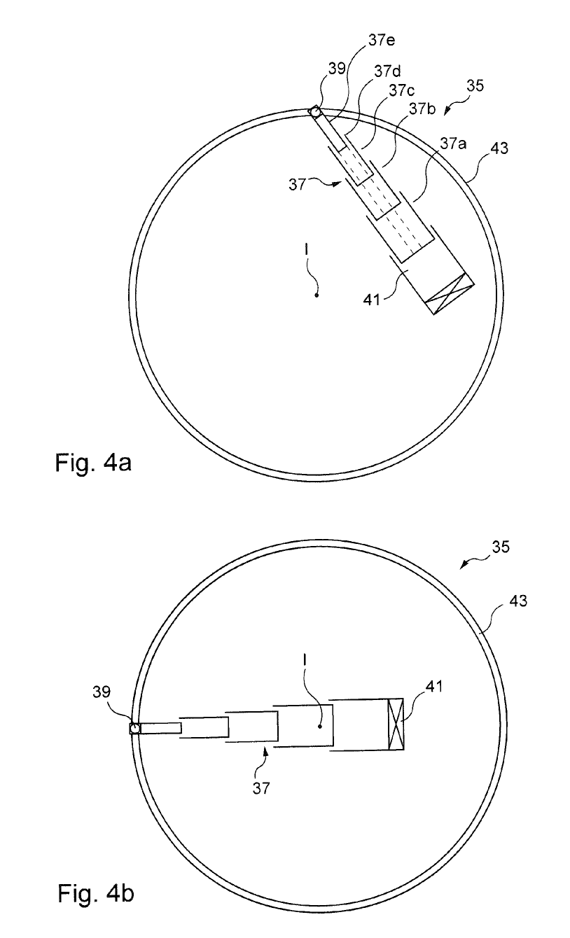

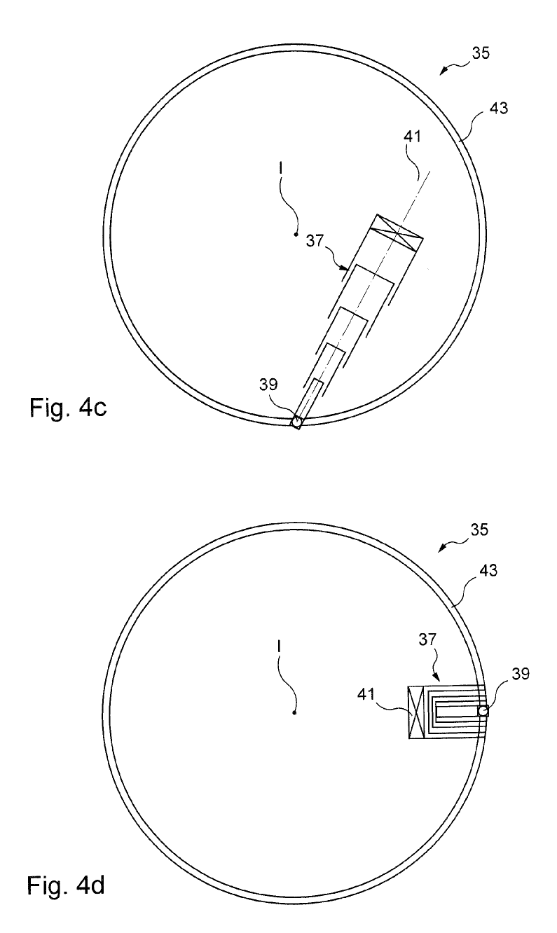

FIGS. 4a to 4d illustrate a fourth embodiment of the mechanism according to the invention;

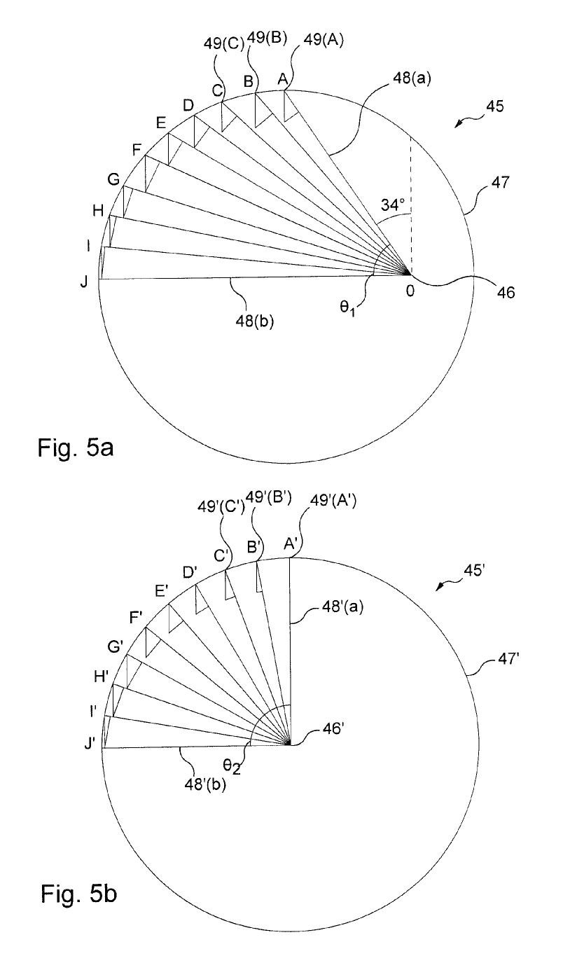

FIGS. 5a to 5b are comparative diagrammatic views of the mechanism according to the invention and a conventional mechanism, respectively;

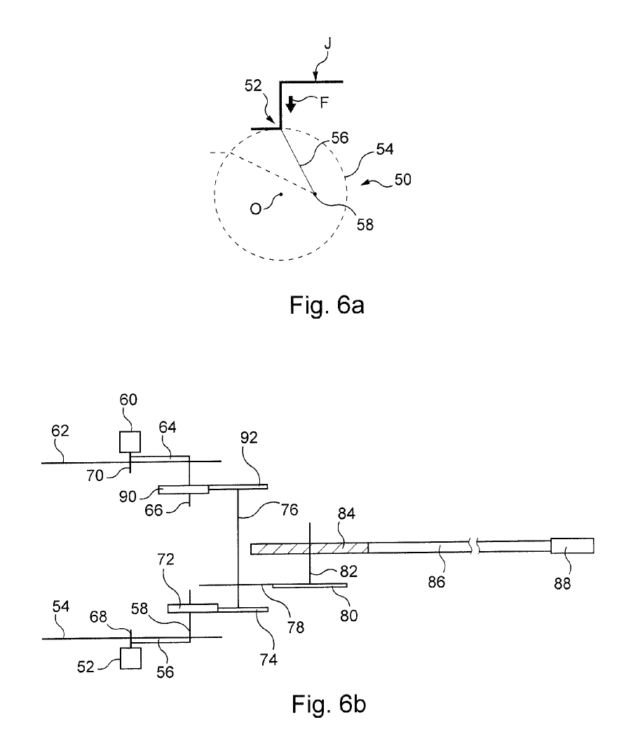

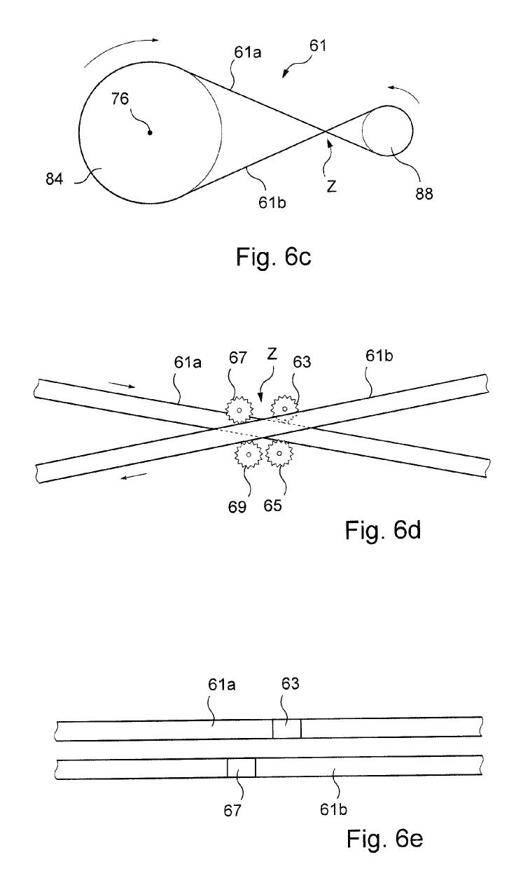

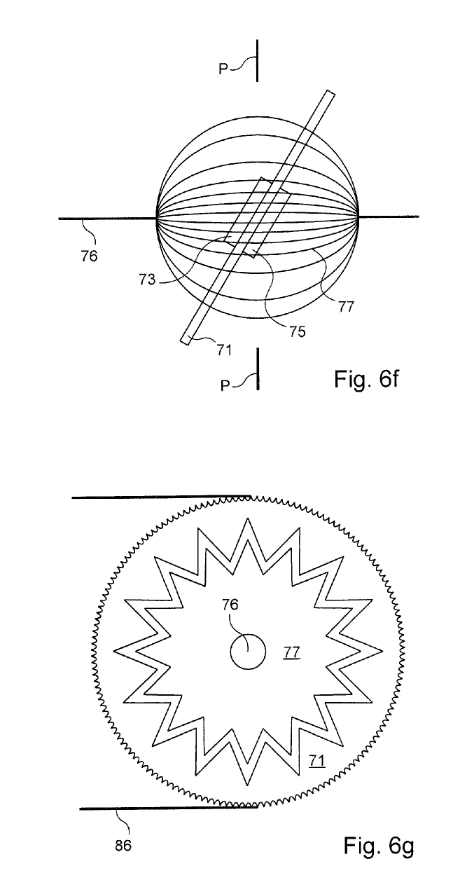

FIG. 6a is a general diagrammatic view of the application of the mechanism according to the invention to a cycle;

FIG. 6b is a more detailed diagrammatic top view of the mechanism of FIG. 6a;

FIG. 6c is a partial diagrammatic view of an alternative embodiment of the mechanism of FIG. 6b;

FIG. 6d is an enlarged partial diagrammatic view of FIG. 6c in the intersection area of the longitudinal chain portions;

FIG. 6e is a diagrammatic top view of FIG. 6d;

FIG. 6f is a partial diagrammatic view of one alternative embodiment of the mechanism of FIG. 6b;

FIG. 6g is an enlarged partial diagrammatic view of the mechanism of FIG. 6f;

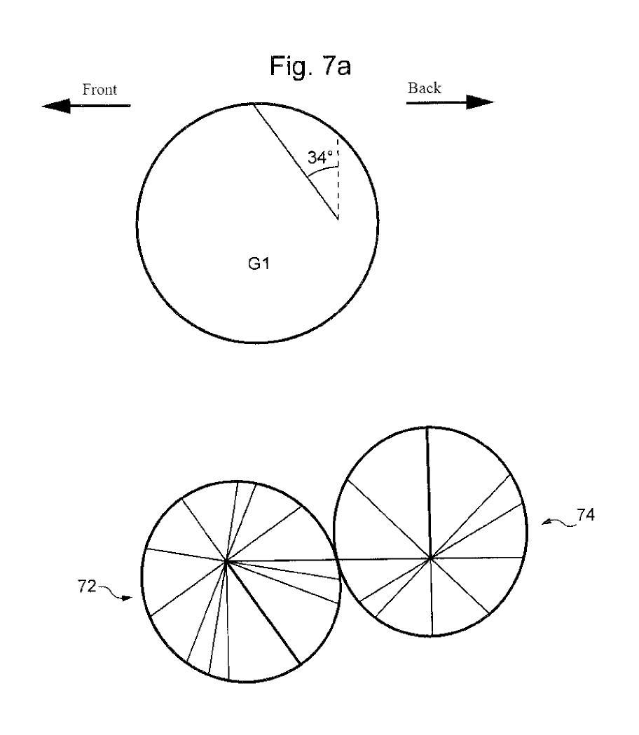

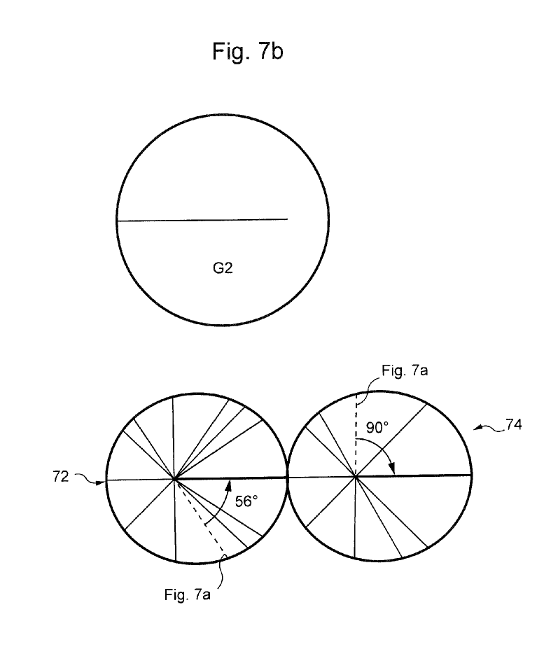

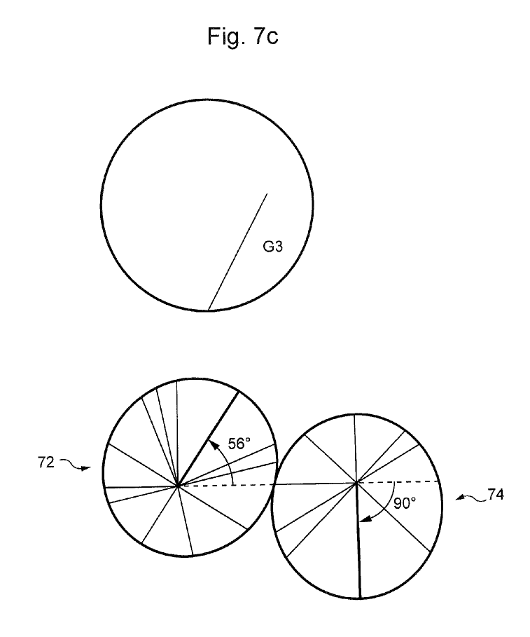

FIGS. 7a-d (8a-d, respectively) illustrate the corresponding positions of the left (right, respectively) pedal and the associated elliptical gears;

FIG. 9 is a general diagrammatic view of an application of a mechanism according to the invention to a piston heat engine.

The present invention relates to a mechanical device, the structure of which is illustrated in FIGS. 1a to 4d, for four embodiments.

As shown in FIG. 1a, the device 10 according to the invention includes a fulcrum element 12 connected to a force transmission rod 14 perpendicular to the plane of the figure by a connecting member 15. The part 16 of the connecting member situated between the fulcrum element and the force transmission rod plays the role of a lever arm.

The device includes a mechanism converting a reciprocating rectilinear movement applied to the fulcrum element 12 (stress F) into a rotational movement of the fulcrum element, that rotation also rotating the force transmission rod 14.

As shown in FIGS. 1a to 1e, one of the characteristics of the device lies in the fact that the length of the lever arm 16 connecting the fulcrum element 12 to the rod 14 varies during the rotation of the fulcrum element and the rod.

More particularly, the distance between the fulcrum element 12 and the rod 14 varies during the relative movement of the fulcrum element with respect to the rod. Thus, FIG. 1b shows that the distance between the aforementioned two elements (fulcrum element and force transmission rod) is larger than in figure la and is also maximal.

In FIG. 1c, the distance between the aforementioned two elements corresponds to the distance illustrated in FIG. 1a, since the position of the two elements of the lever arm is symmetrical relative to a horizontal axis.

Conversely, in FIG. 1d, the distance between the two aforementioned elements is minimal.

In the example illustrated in these figures, the lever arm 16 is secured to the fulcrum element 12, while the force transmission rod 14 is slidingly mounted relative to the lever arm.

As shown in the figures, the fulcrum element 12 cooperates, during its rotational movement, with a guide 18 whereof the shape in this case is circular. The fulcrum element 12 is for example movable relative to the stationary guide 18 and rotates in a slot or neck under the application of a reciprocating rectilinear force, thereby occupying the different positions illustrated in FIGS. 1a to 1d.

It will be noted that the geometric position of the force transmission rod 14 does not vary during these different positions and that that rod remains off-centered relative to the geometric center C of the guide.

As shown in more detail in figure le, the fulcrum element 12 is secured to one end 15a of the lever 15 (connecting member) whereof the central part 15b (in the embodiment described here) is hollow so as to allow one of the ends of the force transmission rod 14 to slide in the recess of the lever 15.

More particularly, the end of the rod 14 is provided with a head 22 whereof the dimensions are adapted to allow sliding.

The hollow central part 15b of the lever 15 forms a guide slot for the force transmission rod 14.

It will be noted that other configurations can be considered to ensure the sliding function of the rod 14 relative to the lever.

The head 22 may for example be replaced by a member in the form of a clamp gripping the outer edges of the lever so as to slide thereon.

The fulcrum element 12 comprises a rod, for example parallel to the force transmission rod 14, that passes through the lever 15 perpendicular to the length thereof and is provided at its emerging end 12a with a pin slidingly mounted relative to the circular guide 18. The emerging end of the fulcrum element can alternatively be provided with a roller.

A ring and ball bearings (not shown) can be provided to allow the rotational assembly and operation of the fulcrum element relative to the guide and the lever 15.

It is thus possible to see that the length of the lever arm 16 is increased during the part of the cycle where the reciprocating rectilinear stress exerted on the fulcrum element 12 is positive. This corresponds to the part of the cycle illustrated in FIGS. 1a and 1c. This part of the cycle is defined, in the entire circular guide, by the area situated between the diametrically opposite extreme positions P1 and P2 of the fulcrum element arranged at the vertical of the geometric center of the guide. This part of the cycle forms an acute angle between P1, P2 and the position (A) of the rod 14 (angle P1AP2).

As illustrated in FIG. 1d, the length of the lever arm between the element 12 and the transmission rod 14 is minimal, and the decrease in the length of the lever arm occurs between FIGS. 1c and 1a.

This results in better use of the reciprocating rectilinear stress communicated to the fulcrum element 12 shown in FIG. 1e, and thus increased mechanical power with a constant force.

Alternatively, the fulcrum element 12 is extended by a guide member installed in the slot or neck (guide path) of the circular or ovoid guide. This guide member has a shape substantially corresponding to the shape of the inner space of the slot (for example, the guide member is in the shape of a hoop or wheel, rigid or flexible, with a circular, semicircular, ovoid, semi-ovoid, etc. shape). Furthermore, rolling means are provided between the guide member and the slot to allow the member to move inside the slot.

According to another alternative embodiment, the circular or ovoid guide has a convex part for fastening the concave fulcrum element sliding on the convex part. For example, the guide comprises a circular or ovoid rail and the fulcrum element comprises, at the end thereof, a slider suitable for being attached on the rail and sliding thereon.

FIGS. 1f to 1h illustrate different examples of possible embodiments in cross-section of a cooperation structure between a fulcrum element A (connected to a lever arm B) having a concave fastening part and a circular or ovoid guide C having a convex complementary fastening part.

In FIGS. 1f and 1g, the guide C is for example a guide rail comprising a raised central portion C that extends from a pedestal C2.

The concave fastening part A1 of the fulcrum element has a general shape with an open profile that has a transverse section in the shape of a sideways C.

Rolling members D are provided to allow the pedestal C2 of the rail to slide inside the profile.

In FIG. 1f, the fastening part in the shape of a sideways C′ is arranged aligned with the fulcrum element at the end thereof, while in FIG. 1g, this part extends laterally relative to the general elongated shape of the fulcrum element, at the end of said fulcrum element.

FIG. 1h illustrates another embodiment in which the guide C′ (guide rails) comprises a raised portion C3 extending from a pedestal or base C4.

The guide is aligned with the fulcrum element A, oriented across from said fulcrum element, and not off-centered as in FIG. 1g.

The concave fastening portion A2 of the fulcrum element is in a general shape with an open profile that has a C-shaped transverse section. The two opposite curved ends of the C cooperate with a throat or groove formed in the junction between the raised portion C3 and its pedestal C4.

The respective inner shapes and dimensions of the cavity of the fastening part A2 and outer shapes and dimensions of the fastening part of the guide are complementary to ensure good cooperation. Rolling means (e.g., ball bearings), not shown, are arranged between the two parts.

FIGS. 1i and 1j (cross-sectional views) illustrate a cooperating structure between a fulcrum element A (connected to a lever arm B) having a convex fastening part and a circular or ovoid guide C″ having a concave complementary fastening part.

The guide C″ is in the extension of the fulcrum element A and is in the general shape of an open profile in the shape of a sideways C.

The end of the fulcrum element A comprises the convex fastening part A3, A4, which extends perpendicular to the extension axis of the fulcrum element, like a “sideways T.”

A “T” has a horizontal bar, here called the head, and a vertical bar, here called the body.

The fastening part forms the head of the T, which cooperates with the inner cavity having a shape and dimensions substantially complementary to those of the guide C″.

Rolling means (e.g., ball bearings), not shown, are arranged between the two parts.

In FIG. 1j, the contact occurs by means of rolling members R (ball bearings, rollers, etc.) for example arranged at each of the two ends of the head of the T.

It will be noted that the different examples of fastening forms between the fulcrum element and the guide also apply to the embodiments and alternatives that will be described hereafter.

The mechanical device 30 of FIGS. 2a to 2d illustrates a second embodiment in which a fulcrum element 32 is connected to a force transmission rod 34 by a lever arm 36. The fulcrum element 32 is movably mounted relative to the lever arm, while the latter is secured to the force transmission rod.

A guide 38, also circular, cooperates with the fulcrum element 32 during the rotational movement of the latter so as to guide the rotation thereof.

Like the lever arm 16 relative to the lever 15 of FIGS. 1a to 1e, the lever arm 36 is part of a lever 40. The central part of the lever is hollow to allow the relative movement of the fulcrum element 32 with respect to the force transmission rod 34 during the rotational movement.

The fulcrum element 32 also assumes the form of a rod that is perpendicular to the plane of FIGS. 2a to 2d (like the rod 34) and is also provided with cooperation means between the fulcrum element and the guide 38.

The means described in reference to FIG. 1e also apply in this second embodiment, as well as the other embodiments.

As shown in FIGS. 2a to 2d, the successive positions of the fulcrum element 32, the rod 34 and the lever 40 show an increase in the length of the lever arm between FIGS. 2a and 2b to reach a maximal distance in FIG. 2b, and a decrease in the lever arm between FIGS. 2b and 2c to reach a minimal distance in FIG. 2d.

It will be noted that the characteristics and advantages described relative to FIGS. 1a to 1e also apply to the embodiments shown in FIGS. 2a to 2d.

Furthermore, in the two embodiments, the element that is stationary relative to the latter is arranged at one of the two ends thereof.

Alternatively, the fulcrum element and the force transmission rod are slidingly mounted relative to the lever arm.

Furthermore, the guide shown in the two embodiments is circular, but may assume other forms, for example such as an ovoid form.

In the embodiments of FIGS. 2a to 2d, the force transmission rod 34 is also offset relative to the geometric center G of the guide.

Irrespective of its shape, the guide of FIGS. 2a to 2d, like that of FIGS. 3a to 4d, is for example made up of a circular trough or slot, as described relative to FIGS. 1a to 1e.

In order to reduce the frictional stresses exerted between the part of the fulcrum element connected to the guide (for example, the pin) and the trough of the guide, ball bearings may be used, as described relative to FIGS. 1a to 1e.

FIGS. 3a to 3d illustrate four successive positions of a mechanism according to a third embodiment of the invention.

The illustrated positions correspond to the positions already described relative to FIGS. 1a to 1d and 2a to 2d for different mechanisms.

The mechanism 25 of FIGS. 3a to 3d differs from that of the preceding figures in that the two distinct elements, i.e., the fulcrum element 27 and the force transmission rod 29, are mounted slidingly relative to the lever 31.

More particularly, these two elements are mounted slidingly relative to the lever arm 33. Thus, during the rotational movement (around the center H) guided by the guide 18, the lever moves in translation relative to the two elements 27 and 29, as illustrated in the figures.

The other characteristics and advantages already described relative to the previous figures apply here, and will not be repeated.

The mechanism 35 of FIGS. 4a to 4d differs from that of the previous figures by the fact that the lever arm 37 connecting the fulcrum element 39 to the force transmission rod 41 is telescopic.

During the rotational movement (around the center I) guided by the circular (or ovoid) guide 43, the length of the lever arm 37 varies by deployment (or extension), between FIG. 4a and FIG. 4b (maximum length), or retraction, between FIG. 4b and FIG. 4d (minimum length). Between FIG. 4d and FIG. 4a, the assembly deploys again.

The lever arm, or more generally the lever, comprises a series of cylindrical portions 37a-e or cylinders that are each open at one end and interlocked with one another. Thus, in the fully retracted position (FIG. 4d), the cylindrical portions are all interlocked or stacked on one another like “Russian nesting dolls.” Each cylindrical portion 37a-d has, at its open end, one or more stops (e.g., rim) cooperating with the closed end of the cylinder portion that it receives so as to retain the latter in particular in the maximum deployed position (FIG. 4b).

The end portion 37e may, like the other portions, slide inside the cylindrical portion that receives it (e.g., 37d).

However, at its opposite end, the end portion 37e is connected to the fulcrum element, for example using one of the techniques already described relative to the previous figures.

The opposite cylindrical end portion, or base, 37a is connected to the force transmission rod 14 in a known manner.

The mechanism 35 is more compact than the other mechanisms, since, during the rotational movement, no parts protrude beyond the guide 43. The bulk of the system is thereby reduced.

The other characteristics and advantages already described relative to the previous figures apply here and will not be repeated.

FIGS. 5a and 5b are comparative views respectively showing the difference between a mechanism 45 according to the invention (FIG. 5a) and a conventional mechanism (FIG. 5b). In the mechanism 45, the force transmission rod 46 is off-centered relative to the center of the circular guide 47 and the length of the lever arm 48 situated between the rod 46 and the fulcrum element 49 varies between the positions (a) and (b) of the fulcrum element 49.

The energy E1 is produced by the mechanism 45 during the movement between the two positions (a) and (b) of the lever arm.

The conventional mechanism 45′, in which the force transmission rod 46′ coincides with the center of the circular guide 47′ and in which the length of the lever arm 48′ between the rod 46′ and the fulcrum element 49′ is constant, produces an energy E2 lower than E1, or a ratio E1/E2 for example equal to 1.26.

This calculation is based on a force of 1 Newton applied vertically to the fulcrum element 49, 49′, and on the fact that in the configuration of FIG. 5a, the rod 46 has been offset from the geometric center by a distance such that the angle θ₁ between the positions 48(a) and 48(b) is for example 56°. In FIG. 5b, the angle θ₂ is 90°.

The performance of the force exerted on the fulcrum element 49 is thus considerably improved with the mechanism according to the invention.

It will be noted that in the respective initial positions 49(A) and 49′(A′) of FIGS. 5a and 5b, the energy produced is very different. In fact, the energy produced in the first positions 49(A), 49(B) and 49(C) is much greater than that produced for the first positions 49′(A′), 49′(B′) and 49(C′). The energy produced between the end positions a and b varies between 40% and 100% in FIG. 5a, and between a value close to 0% and 100% in FIG. 5b. In the case of a cycle, this amounts to greater ease of use for the user of the cycle.

The invention generally presented above is particularly relevantly applicable to a cycle using a pedal crank mechanism.

FIG. 6a diagrammatically illustrates a part of a pedal crank mechanism of a cycle, and

FIG. 6b shows a more detailed top view of the mechanism.

The remaining parts of the cycle that have not been shown remain unchanged relative to a traditional cycle.

The mechanism 50 of FIG. 6a comprises two fulcrum elements, only one 52 of which is shown in that figure and assumes the form of a pedal on which a user places his foot and exerts a reciprocating rectilinear stress.

A bent leg, denoted J, of the user has been shown with the foot positioned on the fulcrum element 52 and exerting a reciprocating rectilinear stress which, in the position of FIG. 6a, is illustrated by arrow F.

The fulcrum element 52 moves in combination with a circular guide 54, and that fulcrum element is connected by a lever arm 56 (crank) to a force transmission rod 58 called primary rod.

The center O of the circular guide 54 is shown offset relative to the rod 58 so as to illustrate the off-centered position of that rod relative to the geometric center of the guide.

FIG. 6a also shows, in dotted lines, the assembly formed by the fulcrum element 52, the lever arm 56 and the rod 58 in a subsequent position obtained by rotating the fulcrum element under the action of a reciprocating rectilinear movement imposed by the length of the user.

The connection between the fulcrum element 52 and the rod 58 can be done according to one of the embodiments shown in FIGS. 1a to 4d so that the length of the lever arm 56 can vary during the relative movement of the fulcrum element 52 with respect to the rod 58.

FIG. 6b shows a top view of the mechanical device according to the invention as applied to a cycle.

The elements 52, 54, 56 and 58 described in reference to FIG. 6a make up the left part of the device.

Symmetrically, the device 50 also comprises a pedal 60 making up a fulcrum element cooperating, during its rotational movement, with a circular guide 62 and that is connected by a lever arm 64 (right crank) to a force transmission rod 66.

The two pedals occupy respective positions that are opposite relative to the geometric center of the guide.

It will be noted that each pedal is fixed to the trough of the circular guide with which it cooperates using a pin (68 for the left pedal and 70 for the right pedal) that is engaged in the corresponding circular guide.

This pin is fixed to one of the ends of the corresponding pedal.

The axis of rotation of the primary shaft (force transmission rod) is off-centered relative to the geometric center of the circular guide, as mentioned above.

As a result, the symmetry of the position of the pedals during their circular travel is no longer respected relative to the geometric center of the circular guide, but is respected relative to the aforementioned axis of rotation.

To that end, each force transmission rod 58, 66 is connected to a complementary mechanism for reestablishing the symmetrical position of the two pedals relative to one another with respect to the geometric center of the guide.

Each complementary mechanism in particular comprises a pair of elliptical gear rings that mechanically cooperate with each other.

One of the rings, called first ring, is connected to the corresponding force transmission rod or primary rod.

More particularly, the primary rod 58 of the left pedal is connected, on the side opposite the crank support 56, to an off-centered ovoid gear ring 72 which in turn is alongside an off-centered ovoid gear ring 74.

These two ovoid gear rings are meshed with one another and rotate around themselves while cooperating with one another, following the rotation of the primary rod.

The second ovoid ring 74 is connected to a long rod 76 and rotates the latter.

A simple gear ring 78 is mounted on the long rod 76 for example centered, and cooperates by meshing with another simple gear ring 80, of the same size as the gear 78.

These two rings 78 and 80 make up a set of simple gears. The ring 80 is mounted on one end of the rod 82 that is short with respect to the rod 76 and is connected, by its opposite end, to the ring 84 of the chain 86, which is connected to the rear wheel.

At one end of the chain opposite that where the ring 84 is located, a rear pinion 88 is shown that is driven by the chain in its movement around the ring 84 around which the chain is wound.

According to one alternative not shown, the chain ring 84 is directly connected to the long rod 76 and the two simple gear rings 78 and 80 are offset and arranged between the chain 86 and a rear pinion 88.

It will be noted that, symmetrically to the arrangement described relative to the primary force transmission rod 58, a pair of elliptical gear rings 90 and 92 mechanically cooperating with each other is arranged between the primary rod 66 and the long rod 76.

More particularly, a first off-centered elliptical gear ring 90 is mounted on the primary rod 66 at an end opposite the crank support and cooperates by meshing with a second off-centered elliptical gear ring 92. This second ring is fixed to one end of the long rod 76, that end being opposite that to which the elliptical gear ring 74 is fixed.

The two gear rings 90 and 92 are identical to each other and are identical to the rings 72 and 74 in this embodiment.

According to one alternative, it should be noted that the two independent mechanisms for reestablishing the symmetrical position of the pedals can be replaced by a single mechanism, for example a single pair of elliptical gears.

It will be noted that the elliptical gear rings can be replaced with other means making it possible to reestablish the symmetrical position of the pedals relative to one another with respect to the geometric center of the circular guide.

For example, chains may be used in place of said gears.

It will be noted that the guides 54 and 62 have been described as circular, but may of course assume another shape, such as an ovoid shape. Depending on the shape of the guides, other conjugated gear profiles may be used (gear with three lobes, peanut-shaped, etc.). The off-centered ovoid rings have an identical shape and are placed such that by pivoting around their respective axes, they are always in contact. Their ratio is 1 to 1 when the rod of the left pedal performs a 360° rotation. However, the off-centered position of these rings makes their speed of rotation inside a revolution sinusoidal. One will rotate in the opposite direction faster than the other during the first 180°, and vice versa. This system allows the short rod 82 to rotate over a complete revolution at exactly the same rhythm as the left pedal on its circular guide. Thus, when the left pedal performs a 90° journey relative to the center of the circular guide, the short rod also performs a 90° rotation at the same time.

As an example, if the primary rod 58 is offset relative to the center of the circular guide O and is on a straight line perpendicular to the direction of the movement of the exerted stress (direction contained in the same plane as that of the guide or in a parallel plane), such that the angle between the theoretical position of the crank that would be situated vertically at the center of the circular guide O and the real position thereof is 34°, then the off-centered gear system of the left pedal should advance by 34° inside a half-revolution, and withdraw by 34° during another half-revolution.

For the off-centered gear system to be offset by +34° within a half-revolution, then −34° within a second half-revolution, it must be built such that the angle APB (formed by three points, one P being one of the foci of the ellipse, the second A being the point of intersection between the circumference of the ellipse and the straight line that passes through the first focus orthogonal to the line that passes through both foci, and the third B being the point of intersection between the circumference of the ellipse and the straight line that passes through the second focus orthogonal to the line that passes through the two foci) is equal to 34° .

It will be noted that the aforementioned angle is at most 45° with a circular guide and can adopt a theoretical threshold value of 90° with an ovoid-shaped guide (for example, elliptical).

The pedals of the cycle thus formed preserve complete symmetry relative to the center of their respective guide.

The chain ring is situated on the short rod 82 connected to the long rod 76 by a set of traditional gears developing 1 to 1 over the course of an entire revolution, so that the chain ring rotates in the same direction as the half-rods of the pedals.

FIG. 6c illustrates one alternative embodiment of the mechanism of FIG. 6b in which the set of gears 78, 80 mounted on the rod 82 is eliminated and the rod 76 connecting the two rings 74 and 92 is then directly mounted on the chain ring 84.

FIG. 6c illustrates an arrangement in which the chain 61 replaces the chain 86 of FIG. 6b and is wound around the chain ring 84 on the one hand, and the rear pinion 88 on the other hand, while being crossed between the ring and the pinion so as to substantially form an 8.

As shown in FIG. 6c, the chain 61 comprises two longitudinal portions or strands 61a, 61b that intersect at an intersection zone Z that is situated close to the rear pinion 88 and is relatively distant from the chain ring 84.

In order to prevent the two longitudinal chain portions 61a and 61b from rubbing against each other, one or more elements for maintaining a lateral separation between those two chain portions are provided.

This or these element(s) are in particular mounted on the frame of the cycle, which is not shown here for simplification reasons.

FIG. 6d illustrates an enlarged diagrammatic view of the intersection zone Z of the two longitudinal portions 61a and 61b and the separating elements provided to maintain the separation.

Thus, two maintaining elements, which here for example assume the form of guide wheels, are arranged on either side of each longitudinal portion 61a, 61b and cooperate therewith so as to maintain sufficient lateral separation between the latter parts.

As shown in FIG. 6d, a pair of guide wheels 63, 65 is arranged above and below the longitudinal portion 61a, while another pair of guide wheels 67, 69 is arranged above and below the longitudinal portion 61b.

FIG. 6e shows a very diagrammatic top view of the laterally offset arrangement of the two upper wheels 63 and 67.

In the arrangement of FIGS. 6d and 6e, the two pairs of wheels are longitudinally offset relative to one another.

However, the two pairs may, according to one alternative, be arranged in a same longitudinal position, each cooperating with a longitudinal chain portion.

This arrangement may for example be useful to facilitate fixing on the frame and, for example, to make the fixing system more compact.

It will be noted that the lateral separation to be maintained between the two longitudinal chain portions is for example equal to approximately the thickness of one longitudinal chain portion, that dimension being shown in FIG. 6e.

Thus, for example, each longitudinal portion 61a, 61b only needs to be offset by a half-thickness or width of a longitudinal chain portion relative to a median position that each longitudinal portion would occupy situated one above the other in the event no intersection was present.

As an example, a separation of 0.8 cm between the two longitudinal chain portions for a standard chain may be sufficient.

It will be noted that a single separation maintaining element (for example, guide wheel) can be provided for each longitudinal chain portion instead of two, according to one alternative.

According to another alternative, a single element inserted between the two longitudinal chain portions may be considered.

FIGS. 6f and 6g illustrate another alternative embodiment making it possible to do away with the set of gears 78, 80 of FIG. 6b.

In this alternative, the rod 76 connecting the two rings 74 and 92 to each other is mounted directly on the chain ring, which here is referenced 71 in FIGS. 6f and 6g.

The particularity of this alternative lies in the fact that the chain ring 71 is inclined relative to a vertical plane P and is connected by the chain 86 to the rear pinion 88, which remains arranged vertically.

Guides, for example two guides, shown in FIG. 6f with references 73 and 75, are fixed to the frame of the cycle, not shown out of a concern for legibility of the figure.

These guides are provided on either side of the chain ring 71 so as to keep the latter part in the inclined position.

It will be noted that the guides are for example arranged on the periphery of the ring 71.

The ring 71 is mounted on a hub or core 77 using interlocking elements mounted matching both on the ring and the hub and complementary with each other so as to fit into each other.

Different interlocking elements are possible, for example such as alternating hollows and projections on the chain ring and on the hub corresponding to one another so that the projections of one interlock in the hollows of the other.

The hub for example here is generally in the shape of an ellipsoid that is elongated along an axis perpendicular to the vertical plane and which here is combined with the rod 76. The interlocking elements formed on the surface of the hub 77 thus assume the form of slots or notches that extend along the curve of the ellipsoid. These elements begin at an end combined with the rod 76 and extend longitudinally following the profile of the ellipsoid to the other end situated on the rod 76.

The height/depth of the successive peaks and hollows formed by the arrangement of the slots side-by-side (transverse section) increases starting from one end to the median plane (equatorial plane) of the ellipsoid to then decrease toward the other end.

The complementary interlocking elements of the chain ring 71 for example assume the form of teeth whereof the tips and hollows between the tips cooperate with the successive slots (hollows and peaks) so as to perform interlocking.

It will be noted that a certain lateral play or gap is necessary between the complementary interlocking elements so as to allow the relative movement of the ring 71 with respect to the slotted/notched hub 77 during a rotational movement.

The incline of the ring is relatively small, typically several angular degrees, and is maintained during a rotational movement of the ring-hub assembly owing to the guides 73 and 75.

It will be noted that the number of guides ensuring the incline of the ring during the rotational movement can vary, as can their position.

The hub on which the chain ring is mounted can assume other forms allowing the ring to be mounted on the hub and allowing them to rotate around the rod 76.

The interlocking elements of the hub or core (the assembly formed by the ring and the hub operates a bit like a ball joint) may assume other forms and may for example assume the form of a series of hollows and bosses, gaps, etc.

FIGS. 7a-d show several successive positions G1 to G4 of the left pedal 52 of FIG. 6b (corresponding to the positions illustrated in FIGS. 1a to 4d) and, in a corresponding manner, each time the relative position of the elliptical gears 72 and 74 seen from the front and which cooperate with each other.

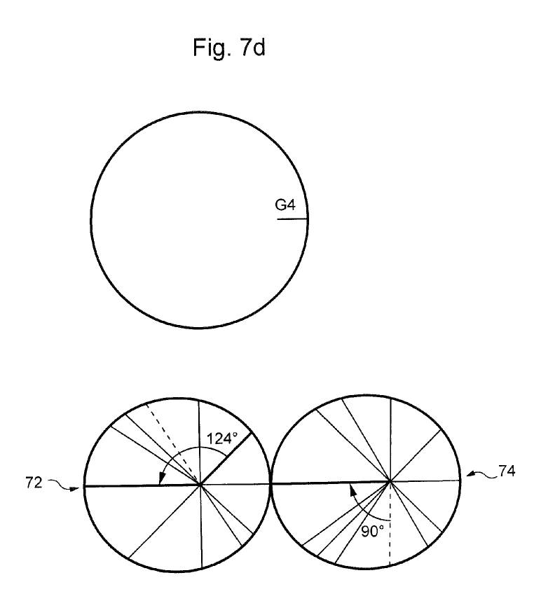

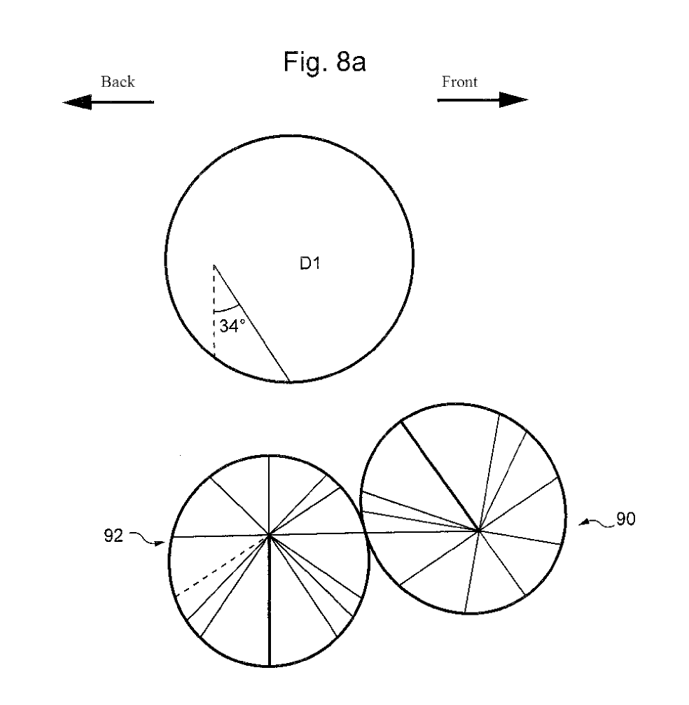

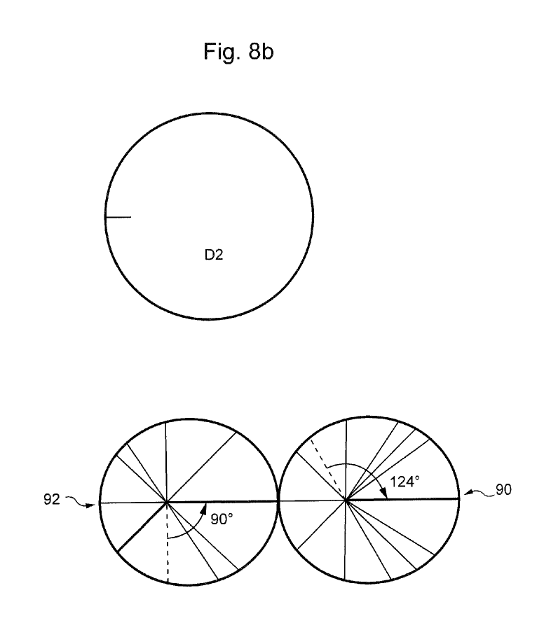

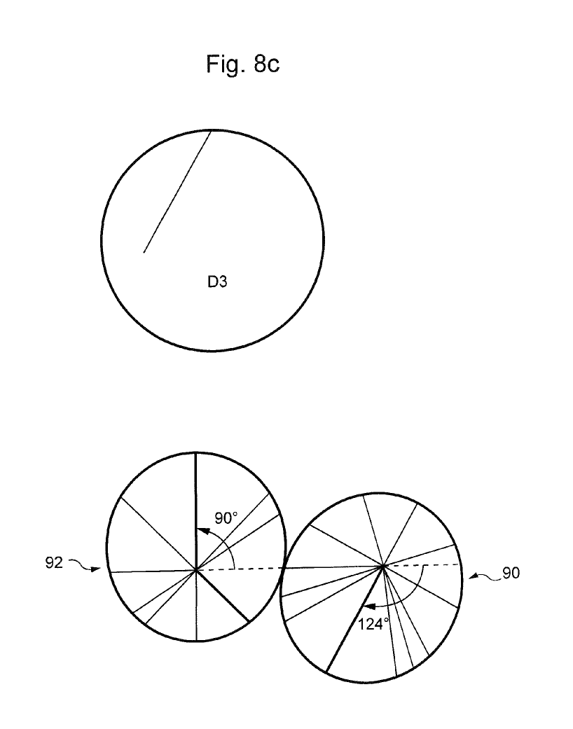

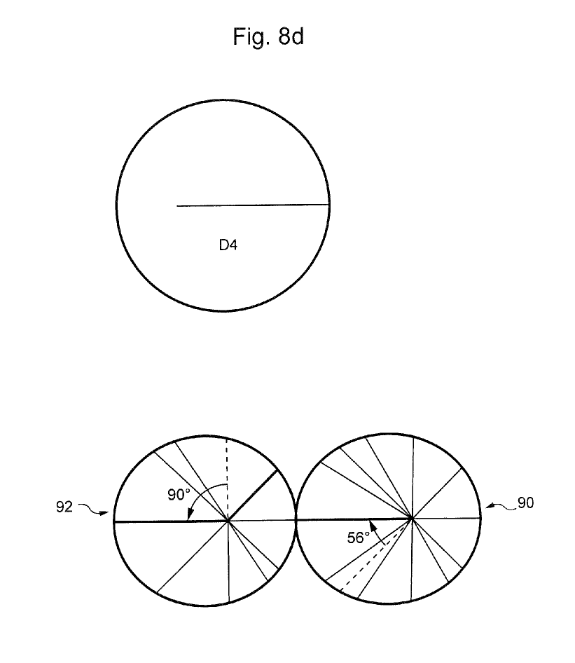

FIGS. 8a-d illustrate the corresponding views of the successive positions D1 to D4 for the right pedal 60 and the relative position of the elliptical gears 90 and 92 associated with that pedal.

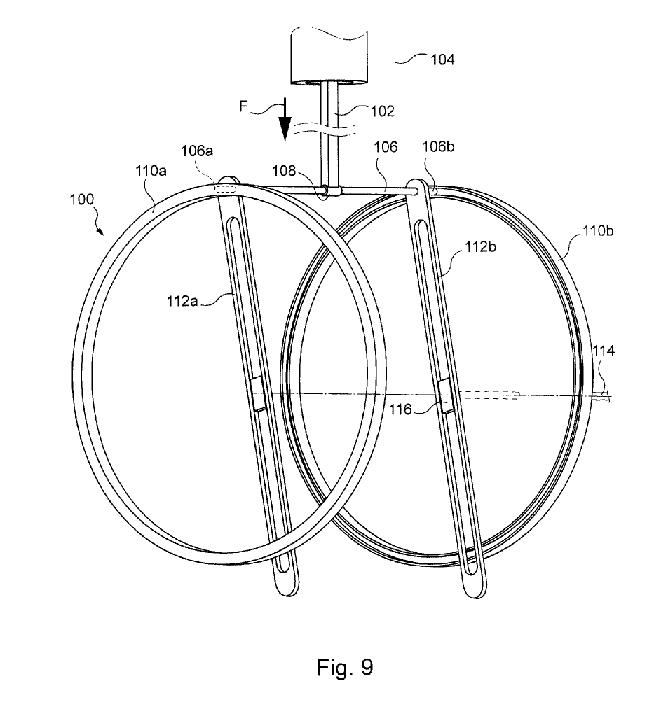

FIG. 7a illustrates the initial position of the left pedal, here denoted G1 (for example, corresponding to the position of FIGS. 1a, 2a, 3a and 4a) with the lever arm arranged at a 34° angle (non-limiting example) relative to the vertical and the corresponding relative position of the gears 72 and 74: FIG. 72 is offset by +34° relative to the descending vertical position it should have, while the gear 74 adopts an upwardly-oriented vertical position (large axis of the vertical ellipse).

In FIG. 8a, the right pedal is in its initial position, here denoted D1, corresponding to that of the pedal G1. The lever arm is arranged toward the bottom forming a −34° angle with the vertical. The gear 92 adopts a downwardly-oriented vertical position, while the gear 90 is offset by −34° with respect to the ascending vertical position it should have.

In FIGS. 7b and 8b, the respective lever arms of the two pedals are horizontal (diametrically opposite positions) and the respective gears are both arranged horizontally (large axis of the horizontal ellipse).

FIGS. 7b to 8d show, on each gear, in thick lines, the new position of the large axis of the ellipse, and in dotted lines, the position of the large axis from the previous figure, as well as the measurement of the angle between those two positions.

FIG. 7c illustrates the position of the pedal corresponding to FIGS. 1c, 2c, 3c and 4c) with the gear 72 offset by −34° relative to the vertical position it should have, while the gear 74 adopts a descending vertical position.

In FIG. 8c, the right pedal is in a symmetrical position relative to the horizontal, the gear 92 adopts an ascending vertical position, while the gear 90 is offset by +34° with respect to the descending vertical position it should have.

In FIGS. 7d and 8d, the respective lever arms of the two pedals are horizontal and the respective gears are both arranged horizontally (large axis of the horizontal ellipse), but in a position situated at 180° with respect to that of FIGS. 7b and 8b.

The invention is also interestingly applicable to piston heat engines, as very diagrammatically shown in FIG. 9.

The device according to the invention 100 comprises a mechanism converting a reciprocating rectilinear movement from a connecting rod 102 connected to a piston 104 moving in a rectilinear movement as indicated by arrow F into a rotational movement.

The mechanism also comprises a stem 106 making up a crankshaft arm whereof the central part is fixed to the connecting rod 102 by fastening means 108.

The arm 106 includes two opposite ends 106a, 106b, which for example are each provided with a pin fixed to a circular or ovoid guide 110a, 110b, respectively.

As previously described for the other embodiments, the guide also has an inner neck in which the pin is inserted.

The reciprocating rectilinear stress applied by the connecting rod 102 on the crankshaft arm 106 transmits a force to the two opposite ends thereof that rotates the crankshaft arm 106 while cooperating with the two guides 110a and 110b.

The ends 106a and 106b make up fulcrum elements that are each connected by a crankshaft crank arm 112a, 112b, respectively, to a primary rod made up of the shank of the crankshaft.

Only the shank of the crankshaft 114 connected to the crank arm 112b has been shown in the drawing out of a concern for clarity.

It will be noted that the embodiment shown in FIGS. 1a to 1e is for example used here.

Thus, each crankshaft arm is hollow in the center thereof to allow a slider 116 fixed to a free end of the rod 114 to slide inside the arm 112b during the rotational movement of the crankshaft arm 106 guided by the associated guide elements 110a and 110b.

As shown in FIGS. 1a to 1e, the position of the force transmission rod 114 is off-centered relative to the geometric center of the corresponding guide.

According to one alternative, the relative movement of each fulcrum element with respect to the corresponding transmission rod (so as to vary the length of the lever arm between those two elements) can be done as illustrated in FIGS. 2a to 2d or in FIGS. 3a to 3d or in FIGS. 4a to 4d.

It will be noted that the advantages of the invention previously described as well as the main features thereof are also repeated in the application illustrated in FIG. 9, with, however, the exception of the reaction mechanism for correcting the symmetry.

Owing to the invention, the mechanical energy produced by the mechanism according to the invention and its mechanical performance are greatly increased relative to the traditional mechanism of the prior art.

1. A mechanical device comprising a mechanism that includes at least one fulcrum element connected to at least one force transmission rod by a connecting member, the mechanism converting a reciprocating rectilinear movement into a rotational movement of said at least one fulcrum element, the rotational movement of said at least one fulcrum element rotating said at least one force transmission rod, wherein the connecting member comprises a part comprising a lever arm which is situated between said at least one fulcrum element and said at least one force transmission rod and has a length that varies over the course of a relative movement of said at least one fulcrum element relative to said at least one transmission rod.

2. The device according to claim 1, wherein said at least one fulcrum element cooperates with a circular or ovoid guide during its rotational movement.

3. The device according to claim 2, wherein said at least one force transmission rod is off-centered relative to a geometric center of the guide.

4. The device according to claim 1, wherein the mechanism comprises two fulcrum elements each connected, by a lever arm, to a force transmission rod.

5. The device according to claim 4, wherein the mechanism comprises two force transmission rods.

6. The device according to of claims 1, wherein the lever arm is secured to said at least one fulcrum element and said at least one force transmission rod is slidingly mounted relative to the lever arm.

7. The device according to claim 1, wherein the lever arm is secured to said at least one force transmission rod and said at least one fulcrum element is slidingly mounted relative to the lever arm.

8. The device according to claim 1, wherein the lever arm is secured to said at least one fulcrum element and said at least one force transmission rod and is telescopic so as to deploy and retract during the rotational movement.

9. The device according to claim 1, wherein said at least one fulcrum element and said at least one force transmission rod are slidingly mounted relative to the lever arm.

10. A cycle comprising the device according to claim 1, said cycle using a crank pedal mechanism in which each pedal constitutes comprises a fulcrum element that is connected to a force transmission rod by a crank arm.

11. The cycle according to claim 10, wherein each force transmission rod is connected to a complementary mechanism for reestablishing a symmetrical position of two pedals relative to one another with respect to a geometric center of a guide with which each pedal cooperates.

12. The cycle according to claim 11, wherein each complementary mechanism comprises a pair of ovoid gear rings mechanically cooperating with each other, one of the rings, called the first ring, being connected to the corresponding force transmission rod.

13. The cycle according to claim 12, wherein the second rings of the two pairs are connected to each other by a transmission rod, a set of gears connecting said transmission rod to a chain ring of the cycle or said transmission rod being directly connected to a chain ring of the cycle and a set of gears being arranged between a chain and a rear pinion.

14. The cycle according to claim 12, wherein the second rings of the two pairs of gear rings are directly connected to a chain ring of the cycle, the chain being crossed between the ring and a rear pinion so as to substantially form an 8.

15. The cycle according to claim 14, wherein including at least one element for maintaining a lateral separation between the two longitudinal portions or chain strands that intersect.

16. The cycle according to claim 15, wherein said at least one element for maintaining the separation comprises, for each longitudinal chain portion, two longitudinal guide elements for said portion that keep it away from the other portion.

17. The cycle according to claim 12, wherein the chain ring of the cycle and/or the rear pinion of the cycle is inclined relative to a vertical plane.

18. The cycle according to claim 17, wherein the chain ring being inclined relative to a vertical plane is mounted on a hub having interlocking elements complementary to those provided on the chain ring so as to allow mounting by interlocking of the ring on the hub and their rotation.

19. The cycle according to claim 18, wherein the hub has a generally elliptical shape that is elongated along an axis perpendicular to the vertical plane.

20. The cycle according to claim 18, wherein the second rings are connected to each other by a transmission rod on which the hub is mounted.

21. The cycle according to claim 17, wherein guides fixed to the frame of the cycle are provided on either side of the chain ring so as to keep the latter in the inclined position.

22. A piston engine comprising the device of claim 1, wherein said piston engine comprises a crankshaft arm which comprises two opposite ends making up two fulcrum elements and two crankshaft crank arms making up the lever arms that respectively connect two opposite ends of the crankshaft arm to the two crankshaft shanks making up two force transmission rods.
